(19) United States
(12) Patent Application Publication
(10) Pub. No.: US 2019/0370248 A1
(43) Pub. Date: Dec. 5, 2019

(54) SYSTEMS FOR REDUCING DATA ERRORS WITHIN A GIVEN DATASET TO PREVENT USER DISENGAGEMENT

(71) Applicant: EndGame Design Laboratories, LLC, Scottsdale, AZ (US)

(72) Inventors: DAVID JUDE LUBERT, Scottsdale, AZ (US); Jessica Markim Birks, Mahwah, NJ (US)

(73) Assignee: EndGame Design Laboratories, LLC

(21) Appl. No.: 16/233,721

(22) Filed: Dec. 27, 2018

Related U.S. Application Data
(63) Continuation of application No. 14/849,543, filed on Sep. 9, 2015, now abandoned.
(60) Provisional application No. 62/048,150, filed on Sep. 9, 2014.

(51) Int. Cl. G06F 16/23; G06F 16/2457; G06F 16/9535

(52) U.S. Cl. CPC G06F 16/2365; G06F 16/9535; G06F 16/24578; G06F 16/24575

(57) ABSTRACT

A system for reducing data errors within a given dataset to prevent user disengagement from an Internet service wherein users provide mutual social or economic benefits to each other is described. The system comprises performing a process for receiving feedback on datasets from service users and transmitting alerts to a particular set of users whose scores fall below a determined threshold. A non-transitory computer-readable medium storing a set of instructions for reducing data errors within a given dataset to prevent user disengagement from an Internet service wherein users provide mutual social or economic benefits to each other is also described.

### PRIORITY

This application is a continuation of U.S. patent application Ser. No. 14/849,543, filed Sep. 9, 2015, which claims priority under 35 U.S.C. § 119 to U.S. Provisional Patent Application No. 62/048,150, filed on Sep. 9, 2014, both of which are herein incorporated in their entirety by reference.

### BACKGROUND

### Technical Field

The present disclosure relates generally to systems for reducing data errors within a given dataset to prevent user disengagement from an Internet service wherein users provide mutual social or economic benefits to each other.

### Background

In an Internet service wherein users interact and provide mutual social or economic benefits to each other, it is often desirable to collect the users' views on the quality of the interactions in the form of user feedback. The feedback from one user on an interaction with a second user may be shared with other users so the other users may decide, upon reviewing the first user's feedback, whether to interact with the second user. An Internet environment facilitates providing a very large amount of feedback to a user in a very short period of time due to remote connectivity, anonymity, and data transmission speeds. In such an environment, well-intentioned users who receive a substantial amount of negative feedback may become disengaged from using the service because their negative feedback would alienate other users from interacting with them. This is undesirable if such well-intentioned users could and are inclined to improve the way they interact with other users. While giving such a well-intentioned user the capability to partially or completely hide their feedback from other users would solve the problem, in doing so one may potentially also hide the feedback of users with no capability or inclination to improve the way they interact with other users. One or more embodiments of the disclosed systems provide a solution to this problem.

A user often provides feedback on an interaction that reflects the degree to which the user's expectations of the interaction were met. In order to increase the users' perception of the quality of an Internet service wherein users interact and then provide feedback on the interactions, it may be beneficial to incentivize users to interact with one another in a manner such that the expectations of all users in the interaction are incorporated into the interaction. Therefore, a system and method for encouraging uncooperative users (i.e., users not interested in participating in interactions in a manner such that other users' expectations are incorporated into the interaction) to stop using the Internet service is desirable.

A system that encourages uncooperative users to stop using the Internet service may confuse benevolent-but-unsuccessful users (i.e., users who genuinely desire to participate in interactions in a manner such that other users' expectations are incorporated into the interaction but who were previously unsuccessful) with those who are simply uncooperative. It is desirable for such a system to differentiate benevolent-but-unsuccessful users from uncooperative users. This is so because proprietors of Internet services generally desire to maximize the number of cooperative users of their service and benevolent-but unsuccessful users may, if given a chance, eventually become such cooperative users. Therefore, avoiding indiscriminately encouraging both uncooperative users and benevolent-but-unsuccessful users to stop using the Internet service is desirable.

Internet services allow for a very large number of users and often derive benefit from a very large number of users. Managing such a large number of users to a service was impractical if not impossible before the advent of Internet and computer technology. Therefore, avoiding indiscriminately encouraging both uncooperative users and benevolent-but-unsuccessful users to stop using the service creates a challenge unique to services that use the Internet. Additionally, because Internet technology facilitates users from distant locations interacting instantaneously through a service, solutions that may have worked for non-Internet services are not practical or effective for Internet services. For example, a non-Internet service may allow for scheduling interviews with each user to determine whether he or she is an uncooperative as opposed to a benevolent-but-unsuccessful user. Doing so for an Internet service, however, would require contacting users in distant locations, in different time zones, speaking different languages, and interviewing thousands or millions of such users. Therefore, a solution to the problem for non-Internet services does not work for Internet services, and another solution is required to determine whether a given user of an Internet service is an uncooperative as opposed to a benevolent-but-unsuccessful user.

### SUMMARY

The present disclosure is directed to systems for reducing data errors within a given dataset to prevent user disengagement from an Internet service wherein users provide mutual social or economic benefits to each other.

Consistent with at least one disclosed embodiment, a system is disclosed for reducing data errors within a given dataset to prevent user disengagement from an Internet service wherein users provide mutual social or economic benefits to each other. In one embodiment this may be accomplished with one or more storage mediums storing datasets for users of the service, wherein at least one element of the datasets is subjective; scores generated based on the user datasets; and instructions for determining whether to issue alerts.

Reducing data errors may also be accomplished with one or more processors configured to execute the instructions, wherein execution of the instructions performs a process comprising receiving a request for feedback based on an interaction between a first user and a second user.

Reducing data errors may also be accomplished with one or more processors configured to execute the instructions, wherein execution of the instructions performs a process comprising receiving quantitative feedback on at least one of the datasets from the first user and the second user.

Reducing data errors may also be accomplished with one or more processors configured to execute the instructions, wherein execution of the instructions performs a process comprising updating the scores based on the received feedback after verifying the receipt of feedback from the first user and the second user.

Reducing data errors may also be accomplished with one or more processors configured to execute the instructions, wherein execution of the instructions performs a process comprising determining a score threshold based on the updated scores.

Reducing data errors may also be accomplished with one or more processors configured to execute the instructions, wherein execution of the instructions performs a process comprising determining a set of users by comparing the updated scores of the users to the determined score threshold.

Reducing data errors may also be accomplished with one or more processors configured to execute the instructions, wherein execution of the instructions performs a process comprising transmitting alerts to the determined set of users, the alerts comprising at least an option to improve an alerted user's score.

Reducing data errors may also be accomplished with one or more processors configured to execute the instructions, wherein execution of the instructions performs a process wherein the alerts comprise messages transmitted over a wireless communication channel.

Reducing data errors may also be accomplished with one or more processors configured to execute the instructions, wherein execution of the instructions performs a process comprising wherein receiving the feedback comprises receiving feedback on the at least one subjective element of the dataset.

Reducing data errors may also be accomplished with one or more processors configured to execute the instructions, wherein execution of the instructions performs a process wherein the datasets include user profiles.

Reducing data errors may also be accomplished with one or more processors configured to execute the instructions, wherein execution of the instructions performs a process wherein the dataset for at least one user comprises spam.

Reducing data errors may also be accomplished with one or more processors configured to execute the instructions, wherein execution of the instructions performs a process wherein the feedback received from the first user comprises a survey on the accuracy of a user profile of the second user.

Reducing data errors may also be accomplished with one or more processors configured to execute the instructions, wherein execution of the instructions performs a process wherein the service comprises a dating application.

Reducing data errors may also be accomplished with one or more processors configured to execute the instructions, wherein execution of the instructions performs a process wherein the service comprises a social network.

Reducing data errors may also be accomplished with one or more processors configured to execute the instructions, wherein execution of the instructions performs a process wherein the service comprises a marketplace.

Reducing data errors may also be accomplished with one or more processors configured to execute the instructions, wherein execution of the instructions performs a process wherein the service comprises a marketed product or service from a third party.

Reducing data errors may also be accomplished with one or more processors configured to execute the instructions, wherein execution of the instructions performs a process wherein the option presents a proposed modification to the user profile.

Reducing data errors may also be accomplished with one or more processors configured to execute the instructions, wherein execution of the instructions performs a process wherein updating the scores based on the received feedback comprises changing the scores for the at least one of the datasets associated with the received feedback, and normalizing the scores for each of the datasets after the scores for the at least one of the datasets associated with the received feedback are changed.

Reducing data errors may also be accomplished with one or more processors configured to execute the instructions, wherein execution of the instructions performs a process wherein the score threshold comprises a score on a probability distribution curve comprising the normalized scores.

Reducing data errors may also be accomplished with one or more processors configured to execute the instructions, wherein the score threshold comprises a score at which there is an inflection below and closest to the median score in the probability distribution curve.

Reducing data errors may also be accomplished with one or more processors configured to execute the instructions, wherein execution of the instructions performs a process wherein the score threshold comprises a score that is the midpoint between (i) the score at which there is a local minimum and that is greater than and closest to the score with a local maximum with the highest probability and below the mean score, and (ii) the mean score.

Reducing data errors may also be accomplished with one or more processors configured to execute the instructions, wherein the score threshold comprises a score that is the midpoint between (i) the score at which there is a local minimum and that is greater than and closest to the score with a local maximum with the highest probability and below the median score, and (ii) the median score.

Other embodiments of this disclosure are disclosed in the accompanying drawings, description, and claims. Thus, this summary is exemplary only, and is not to be considered restrictive.

### BRIEF DESCRIPTION OF DRAWINGS

The accompanying drawings, which are incorporated in and constitute a part of this specification, illustrate the disclosed embodiments and together with the description, serve to explain the principles of the various aspects of the disclosed embodiments. In the drawings:

FIG. 1: Illustrates an exemplary system environment wherein the system for reducing data errors within a given dataset to prevent user disengagement from an Internet service operates.

FIG. 2: Illustrated an exemplary system for reducing data errors within a given dataset to prevent user disengagement from an Internet service.

FIG. 3: Illustrates an exemplary process for reducing data errors within a given dataset to prevent user disengagement from an Internet service wherein users provide mutual social or economic benefits to each other, performed when one or more processors execute the instructions.

FIG. 4: Illustrates an exemplary probability distribution curve comprising the normalized scores wherein the scores have a normal distribution. All points indicated on the curve are approximations, provided for qualitative illustration.

FIG. 5: Illustrates an exemplary probability distribution curve comprising the normalized scores wherein the scores have a non-normal distribution. All points indicated on the curve are approximations, provided for qualitative illustration.

It is to be understood that both the foregoing general description and the following detailed description are exemplary and explanatory only and are not restrictive of the claims.

### DESCRIPTION OF EXEMPLARY EMBODIMENTS

Reference will now be made to certain embodiments consistent with the present disclosure, examples of which are illustrated in the accompanying drawings. Wherever possible, the same reference numbers are used throughout the drawings to refer to the same or like parts.

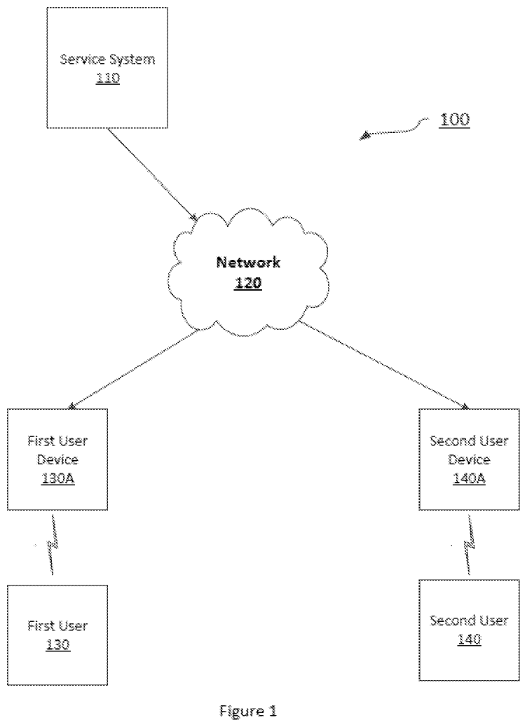

The present disclosure describes systems for reducing data errors within a given dataset to prevent user disengagement from an Internet service wherein users provide mutual social or economic benefits to each other. Such a service may comprise, among other things, a dating application, a social network, marketed product or service from a third party, or a marketplace. The system may operate in an environment such as system environment 100, illustrated in FIG. 1. The environment may comprise a service system 110, a network 120, user devices such as first user device 130A and second user device 140A, and users such as first user 130 and second user 140.

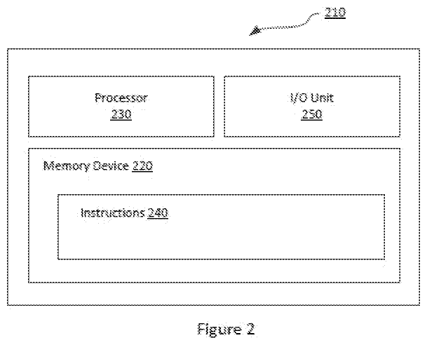

Such a system 210, illustrated in FIG. 2, may comprise one or more storage mediums or memory devices such as 220, storing datasets for users of the service, wherein at least one element of the datasets is subjective. The storage mediums may also store scores generated based on the user datasets and instructions for determining whether to issue alerts.

The datasets may include user profiles, accounts, depictions, or portrayals of one's self or a marketed product, service, or advertisement. The dataset for at least one user may comprise spam.

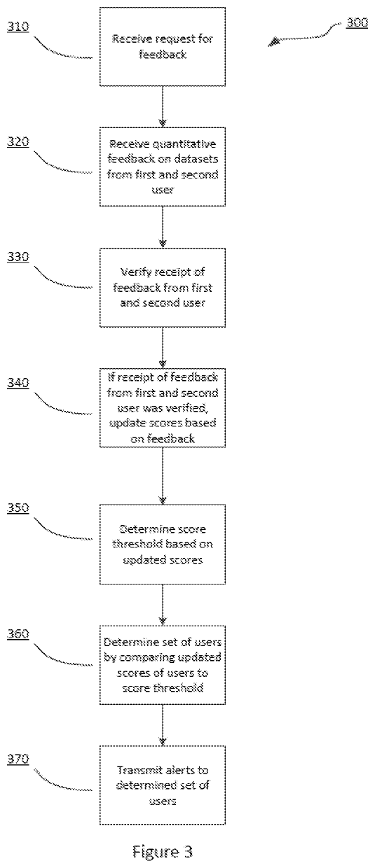

The system 210 of FIG. 2 may also comprise one or more processors 230 configured to execute the instructions 240, wherein execution of the instructions performs a process 300 illustrated in FIG. 3.

In an exemplary system environment 100 of FIG. 1 in which embodiments consistent with the present disclosure may be practiced and implemented includes a system that may include one or more server or service systems 110, databases, and/or computing systems configured to receive information from entities in network 120, process the information, and communicate the information with other entities in the network 120, such as first user 130 and second user 140. For example, the system 110 may be configured to receive data over an electronic network 120 (e.g., the Internet), process/analyze queries and data, and provide an application to users 130 and 140. This may be done over devices 130A and 140A.

The various components of the system 210, illustrated in FIG. 2, may include an assembly of hardware, software, and/or firmware, including a memory 220, a central processing unit (“CPU”), and/or a user interface 250. Memory 220 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. A CPU may include one or more processors, such as processor 230, for processing data according to a set of programmable instructions 240 or software stored in the memory 220. The functions of each processor 230 may be provided by a single dedicated processor 230 or by a plurality of processors. Moreover, processors may include, without limitation, digital signal processor (DSP) hardware, or any other hardware capable of executing software. An optional user interface may include any type or combination of input/output devices 250, such as a display monitor, keyboard, touch screen, and/or mouse.

As described above, the system 110 of FIG. 1 may be configured to receive data over a network (such as an electronic network), process/analyze queries and data, and provide geographic locations to users. Examples of an electronic network 120 include a local area network (LAN), a wireless LAN (e.g., a “WiFi” network), a wireless Metropolitan Area Network (MAN) that connects multiple wireless LANs, a wide area network (WAN) (e.g., the Internet), and a dial-up connection (e.g., using a V.90 protocol or a V.92 protocol). In the embodiments described herein, the Internet may include any publicly-accessible network or networks interconnected via one or more communication protocols, including, but not limited to, hypertext transfer protocol (HTTP) and transmission control protocol/internet protocol (TCP/IP). Moreover, the electronic network may also include one or more mobile device networks, such as a GSM network or a PCS network, that allow mobile devices, such as a first or second user device 130A and 140A, to send and receive data via applicable communications protocols, including those described above. Further, the system may operate and/or interact with one or more host servers, one or more user devices for the purpose of implementing features described herein.

At step 310 of process 300 in FIG. 3, the instructions 240 executed by the one or more processors 230 cause the system to receive a request for feedback based on an interaction between a first user 130 and a second user 140.

At step 320, the instructions 240 executed by the one or more processors 230 cause the system to receive quantitative feedback on at least one of the datasets from the first user and the second user. This may include receiving feedback on the at least one subjective element of the dataset. The feedback received from the first user 130 may comprise a survey, questionnaire, poll, review, inquiry, or study on the accuracy of a user profile, account, depiction, or portrayal of one's self or a marketed product, service, or advertisement of the second user 140. The subjective element may comprise connectivity, adaptability, perception of potential future interactions as a beneficial opportunity, possibility of future interaction, or level to which expectations were met.

At step 330, the instructions 240 executed by the one or more processors 230 cause the system to verify the receipt of feedback from the first user 130 and the second user 140.

At step 340, the instructions 240 executed by the one or more processors 230 cause the system to update the scores based on the received feedback after verifying the receipt of feedback from the first user 130 and the second user 140 at step 330. The scores may be changed for at least one of the datasets, and the scores for each dataset may be normalized after at least one of the scores is changed.

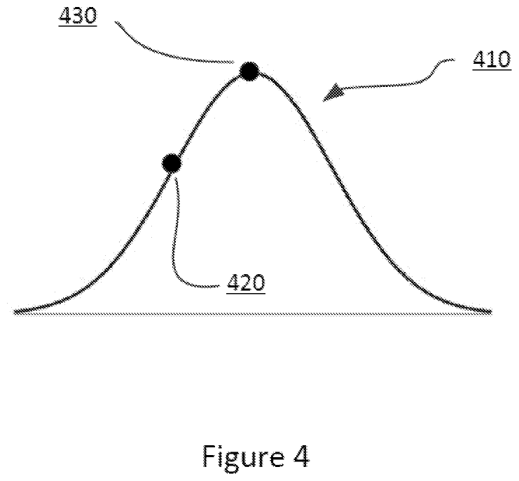

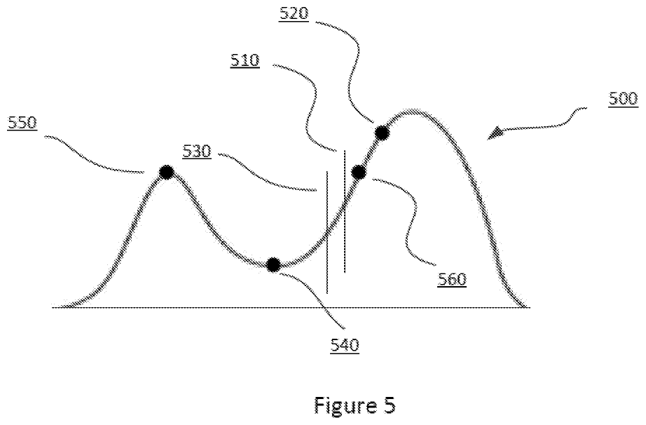

At step 350, the instructions executed by the one or more processors cause the system to determine a score threshold based on the updated scores. The score threshold may be a threshold score on a probability distribution curve 410 of FIG. 4 comprising the normalized scores. While the threshold score may be calculated in any manner, in one embodiment, the score threshold may comprise the score 420 at which there is an inflection below and closest to the median score 430 in the probability distribution curve 410. While this method of determining the score threshold may be used in the cases of both normal and non-normal probability distributions of the normalized scores, in the latter case of a non-normal curve, such as curve 500 of FIG. 5, one may also use the mean score 560 instead of or in addition to the median score 520. When using the median score 520 in the case of non-normal distribution, the score threshold indicated by vertical line 510 may comprise the midpoint between (i) the score 540 at which there is a local minimum and that is greater than and closest to the score 550 with a local maximum with the highest probability and below the median score 520, and (ii) the median score 520. When using the mean score 560 in case of non-normal distribution, the score threshold indicated by vertical line 530 may comprise the midpoint between (i) the score 540 at which there is a local minimum and that is greater than and closest to the score 550 with a local maximum with the highest probability and below the mean score 560, and (ii) the mean score 560. This latter method may yield better data error reduction when the distribution of scores is not normal. All local minima and maxima may be found by, for example, determining where the slope of the curves equals zero and whether the curves are concave or convex in the particular region.

All of the threshold determination methods described may be used instead of or in addition to all other determination methods described.

At step 360 of process 300 in FIG. 3, the instructions 240 executed by the one or more processors 230 cause the system to determine a set of users by comparing the updated scores of the users to the determined score threshold, such as score threshold 470. Such comparison may include stack ranking, segmenting, grouping, sorting, arranging, dividing, assembling, classifying, or batching, the updated scores and all other scores.

At step 370, the instructions 240 executed by the one or more processors 230 cause the system to transmit alerts to the determined set of users, the alerts may comprise, among other things, at least an option to improve an alerted user's score. This improvement may be performed in return for consideration from the user, such as payment or performance of one or more actions. The option may present a proposed modification to the user profile. This modification may be performed in return for consideration from the user, such as payment or performance of one or more actions. The option may allow a user to be eligible for the receipt of additional products or rendering of additional services. The option may allow redistribution, recirculation, or additional publishing of a user's profile, account, depiction, or portrayal of one's self or a marketed product, service, or advertisement.

The alerts may comprise messages transmitted over a wireless communication channel, which may include the Internet, emails, text messages, pop-ups, mobile push notifications, and messages or buttons in user's account within the application.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments include equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for reducing data errors within a given dataset to prevent user disengagement from an Internet service wherein users provide mutual social or economic benefits to each other, the system comprising:
one or more storage mediums storing:
datasets for users of the service, wherein at least one element of the datasets is subjective,
scores generated based on the user datasets, and
instructions for determining whether to issue alerts; and
one or more processors configured to execute the instructions, wherein execution of the instructions performs a process comprising:
receiving a request for feedback based on an interaction between a first user and a second user,
receiving quantitative feedback on at least one of the datasets from the first user and the second user,
verifying the receipt of the feedback from the first user and the second user,
updating the scores based on the received feedback after verifying the receipt of feedback from the first user and the second user,
determining a score threshold based on the updated scores,
determining a set of users by comparing the updated scores of the users to the determined score threshold, and
transmitting alerts to the determined set of users, the alerts comprising at least an option to improve an alerted user's score.

2. The system of claim 1, wherein the alerts comprise messages transmitted over a wireless communication channel.

3. The system of claim 1, wherein receiving the feedback comprises receiving feedback on the at least one subjective element of the dataset.

4. The system of claim 3, wherein the datasets include user profiles.

5. The system of claim 3, wherein the dataset for at least one user comprises spam.

6. The system of claim 4, wherein the feedback received from the first user comprises a survey on the accuracy of a user profile of the second user.

7. The system of claim 6, wherein the service comprises a dating application.

8. The system of claim 6, wherein the service comprises a social network.

9. The system of claim 6, wherein the service comprises a marketplace.

10. The system of claim 6, wherein the service comprises a marketed product or service from a third party.

11. The system of claim 6, wherein the option presents a proposed modification to the user profile.

12. The system of claim 1, wherein updating the scores based on the received feedback comprises:
changing the scores for the at least one of the datasets associated with the received feedback; and
normalizing the scores for each of the datasets after the scores for the at least one of the datasets associated with the received feedback are changed.

13. The system of claim 12, wherein the score threshold comprises a score on a probability distribution curve comprising the normalized scores.

14. The system of claim 13, wherein the score threshold comprises a score at which there is an inflection below and closest to the median score in the probability distribution curve.

15. The system of claim 13, wherein the score threshold comprises a score that is the midpoint between (i) the score at which there is a local minimum and that is greater than and closest to the score with a local maximum with the highest probability and below the mean score, and (ii) the mean score.

16. The system of claim 13, wherein the score threshold comprises a score that is the midpoint between (i) the score at which there is a local minimum and that is greater than and closest to the score with a local maximum with the highest probability and below the median score, and (ii) the median score.

17. A non-transitory computer-readable medium storing a set of instructions that are executable by one or more processors of one or more servers to cause the one or more servers to perform a method for reducing data errors within a given dataset to prevent user disengagement from an Internet service wherein users provide mutual social or economic benefits to each other, the method comprising:
receiving a request for feedback based on an interaction between a first user and a second user,
receiving quantitative feedback on at least one dataset from the first user and the second user, wherein the dataset is for a user of the service and at least one element of the dataset is subjective,
verifying the receipt of the feedback from the first user and the second user,
updating scores, generated based on the datasets for the users of the service, based on the received feedback after verifying the receipt of feedback from the first user and the second user,
determining a score threshold based on the updated scores,
determining a set of users by comparing the updated scores of the users to the determined score threshold, and
transmitting alerts to the determined set of users, the alerts comprising at least an option to improve an alerted user's score.

18. The non-transitory computer-readable medium of claim 17, wherein receiving the feedback comprises receiving feedback on at least one subjective element of the dataset.

19. The non-transitory computer-readable medium of claim 18, wherein the feedback received from the first user comprises a survey on the accuracy of a user profile of the second user.

20. The non-transitory computer-readable medium of claim 17, wherein updating the scores based on the received feedback comprises:
changing the scores for the at least one of the datasets associated with the received feedback; and
normalizing the scores for each of the datasets after the scores for the at least one of the datasets associated with the received feedback are changed.

21. The non-transitory computer-readable medium of claim 20, wherein the score threshold comprises a score at which there is an inflection below and closest to the median score in the probability distribution curve.

22. The non-transitory computer-readable medium of claim 20, wherein the score threshold comprises a score that is the midpoint between (i) the score at which there is a local minimum and that is greater than and closest to the score with a local maximum with the highest probability and below the mean score, and (ii) the mean score.

23. The non-transitory computer-readable medium of claim 20, wherein the score threshold comprises a score that is the midpoint between (i) the score at which there is a local minimum and that is greater than and closest to the score with a local maximum with the highest probability and below the median score, and (ii) the median score.
